(19) United States
(12) Patent Application Publication
(10) Pub. No.: US 2019/0004194 A1
(43) Pub. Date: Jan. 3, 2019

(54) SYSTEM AND METHOD FOR CREATING SEISMIC VIBRATIONS

(71) Applicant: SEISMIC MECHATRONICS B.V., Eindhoven (NL)

(72) Inventors: Ira DVIR, RISHON LEZION (IL); Nitzan RABINOWITZ BATZ, Rosh Ha'ayin (IL); David Haim LANDA, Tel Aviv (IL)

(21) Appl. No.: 16/062,701

(22) PCT Filed: Dec. 15, 2016
(86) PCT No.: PCT/IL2016/051340

§ 371 Date: Jun. 15, 2018

Related U.S. Application Data
(60) Provisional application No. 62/268,524, filed on Dec. 17, 2015.

(51) Int. Cl. G01V 1/00

(52) U.S. Cl. CPC G01V 1/005; G01V 2210/679

(57) ABSTRACT

A system and method for creating seismic vibrations, the system including a Time Reversal Mirroring array including an array of seismic vibrators, an array of geophones, which are located at impact points of the seismic vibrators, for receiving seismic signals from a target area; and a processing unit arranged to receive the received seismic signals from the geophones, time reverse the received seismic signals and provide the time reversed seismic signals to the seismic vibrators for injecting the time reversed seismic signals into the earth towards the target area; wherein the processing unit is configured to orchestrate and synchronize the array of vibrators when injecting the time reversed seismic signals back into the earth.

### FIELD OF THE INVENTION

The present invention relates to a system and method for creating seismic vibrations.

### BACKGROUND OF THE INVENTION

Seismic vibrators have been used for many years as a seismic source for injecting low-frequency vibrations into the earth. A seismic vibrator propagates energy signals into the earth over an extended period of time, as opposed to the near instantaneous energy provided by impulsive sources. Such vibrators are used for reflection seismology. The data recorded using vibrators must be correlated to convert the extended source signal into an impulse. The source signal using this method was originally generated by a servo-controlled hydraulic vibrator or shaker.

The “vibroseis” exploration technique (exploration performed with vibrators) was developed already during the 1950s and today seismic vibrators are used to perform about half of all seismic surveys on land.

Traditionally, seismic vibrators used hydraulic technologies, which are limited in terms of accuracy and impact. The structure of the hydraulic vibrators has a few weak links, which limit its impact, and the most important of them is the hydraulic pump. Also, synchronizing accurately a few hydraulic vibrators or even a neat manipulation of a single vibrator while treating a complex function attempting to inject complex signals into the earth is practically impossible due to the mechanical nature of the hydraulic system.

As a result of the limitations of the vibrators, the effective range of seismic applications in various forms and the impact at target areas, when utilizing an array of seismic vibrators, are limited.

### SUMMARY OF THE INVENTION

The current invention suggests a practical way to enhance the efficiency of vibroseismic applications by amplifying the impact at target areas. The current invention does so by using an array of seismic vibrators, preferably electronically controlled seismic vibrators, with Time Reversal Mirroring and one, or a combination of, the following technologies: Vibrating to Resonance; and/or Directional Signal Acquisition and/or Directional Signal Injection. By utilizing the array of electronically controlled vibrators with one or more of these technologies, the impact of the array of electronic vibrators at the target areas is significantly amplified, compared to the widely used array of hydraulic or electronic arrays of vibrators.

There is provided, according to the present invention, a system for creating seismic vibrations, the system including a Time Reversal Mirroring array including an array of seismic vibrators, an array of geophones, which are located at impact points of the seismic vibrators, for receiving seismic signals from a target area; and a processing unit arranged to receive the received seismic signals from the geophones, time reverse the received seismic signals and provide the time reversed seismic signals to the seismic vibrators for injecting the time reversed seismic signals into the earth towards the target area; wherein the processing unit is configured to orchestrate and synchronize the array of vibrators when injecting the time reversed seismic signals back into the earth.

There is further provided, according to the invention, a method for creating seismic vibrations, the method including acquiring by an array of geophones a seismic wavefield arriving from a target in the earth; processing the acquired wavefield; time-reversing the processed wavefield; and back-propagating the time-reversed wavefield through the earth towards the target.

According to embodiments of the invention, the received signals or the time-reversed seismic signals are amplified before being back-propagated into the earth. There is further provided, according to the invention, a method for enhancing efficiency of vibroseismic applications, the method including injecting seismic energy signals into the earth using an array of electronically controlled seismic vibrators in a direction of a target; acquiring seismic energy signals returned from the target in response to the injected signals; performing Time Reversal Mirroring on the acquired energy signals; and creating seismic signal amplification at the target utilizing at least one of the technologies selected from the group including: vibrating the target to resonance; directional signal acquisition from the target; and directional signal injection towards the target.

### BRIEF DESCRIPTION OF THE DRAWINGS

The present invention will be further understood and appreciated from the following detailed description taken in conjunction with the drawings in which:

FIG. 1 is a schematic illustration of a system for creating seismic vibrations constructed and operative in accordance with one embodiment of the present invention;

FIG. 2 is a schematic illustration of a method for amplifying seismic vibrations according to one embodiment of the invention;

FIG. 3 is a schematic illustration of a system for creating seismic vibrations, according to one embodiment of the invention, in operation;

FIG. 4 is a flow chart of operation of a system according to some embodiments of the invention; and

FIG. 5 is a flow chart of operation of a system according to alternative embodiments of the invention.

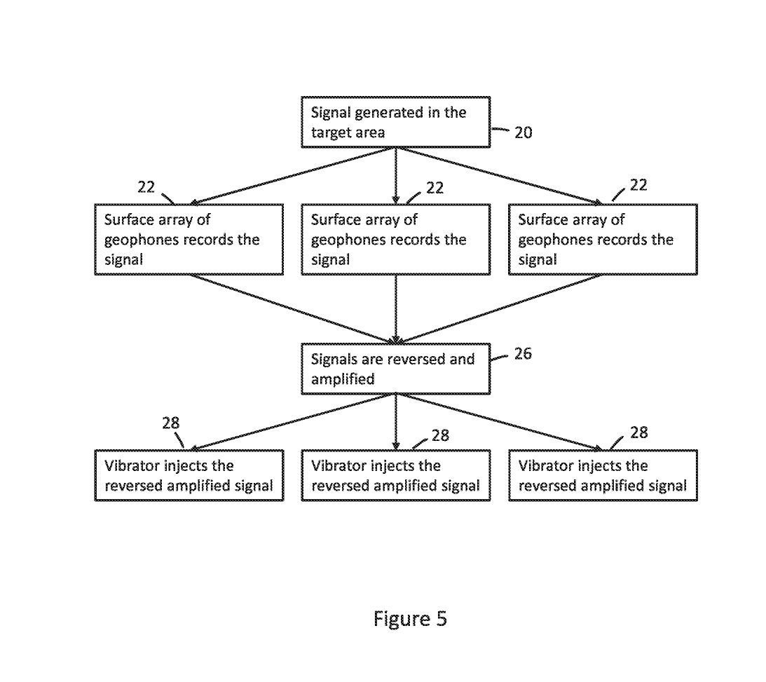

### DETAILED DESCRIPTION OF THE CURRENT INVENTION

The current invention makes use of a few seismic technologies and methods, combining them into a system which is orchestrated to produce an increased impact at target areas. In particular, it utilizes a time reversal mirror (TRM) array system for seismic signal amplification at target areas.

The current invention discloses a Time Reversal Mirror (TRM) Array System that can focus waves using the Time Reversal Method. It is based on the reciprocity of the wave equation: the time reversal (using a negative time) of a solution to the wave equation is also a solution. This means that, to focus seismic energy in a particular area (from an active or passive source), it is enough to record the wavefield arriving from this area and to time-reverse this field. The time-reversed back-propagated wavefield optimally refocuses on the source. When the time-reversed signal is amplified before being back-propagated, the target can be caused to vibrate.

The time reversal method is already used in medical applications: kidney stones destruction (lithotripsy); non-destructing testing; wireless communication; etc.

The current TRM Array System is designed to have an impact at target areas, producing a more effective impact than that of the state of the art array of vibrators. For purposes of the present invention, the TRM Array System includes a plurality of seismic vibrators and a plurality of geophones disposed at the point of impact of the seismic vibrators, and a processing unit that time reverses seismic signals or wavefield received by the geophones for injecting back into the earth by the seismic vibrators. Preferably, the seismic vibrators are electronically controlled seismic vibrators, based on synchronous linear motors.

For synchronized operation and the injection of arbitrary/complex signals into the earth, a preferred embodiment of the current invention makes use of electronically controlled vibrators. Such electronically controlled vibrators, which can be based on linear synchronous motors, can produce—unlike hydraulic vibrators—very accurate signals in a rather wide range of frequencies, and most of all, due to their electronic nature, enable precise synchronization of an array of vibrators.

The precise orchestration and synchronization of the array of vibrators is essential to effective embodiment of a TRM system, as without such precise orchestration and synchronization, adding vibrators to the array of vibrators may not contribute to the impact at the target areas, but instead provide a negative contribution, mixing and interfering with the injected signal at the target point. Modern seismic vibrators are equipped with the newest control systems. These control systems are designed to control individual vibrations, or synchronize entire fleets of trucks carrying seismic vibrators. Using GPS, they control the generated signals with precision and accuracy. (The signal injection of the electronic vibrators is similar to the way a multi speaker home theater system operates.)

Furthermore, in one of many possible embodiments of the current invention, the TRM Array System will use an array of narrow angle directional geophones. Directional geophones practically filter signals, which are generated and spread from beyond the angle of the directional geophone's sensitivity. Such selective reception of signals, or seismic wavefield, could enhance, in practice, the relative difference between an acquired signal from a given target point as compared to background signals. Furthermore, in one of many possible embodiments of the current invention, the TRM Array System will be based on directional vibrators. As the system's aim is to have a greater impact at a target area, the system's array of vibrators preferably would inject the TRM signals at an angle which is targeting the target areas, instead of injecting it in a vertical direction, as is usually done.

Furthermore, in some possible embodiments of the current invention, the TRM Array System will be a resonating system, injecting into the earth a mirrored synchronized vibration at a defined frequency in order to produce resonance at the target areas.

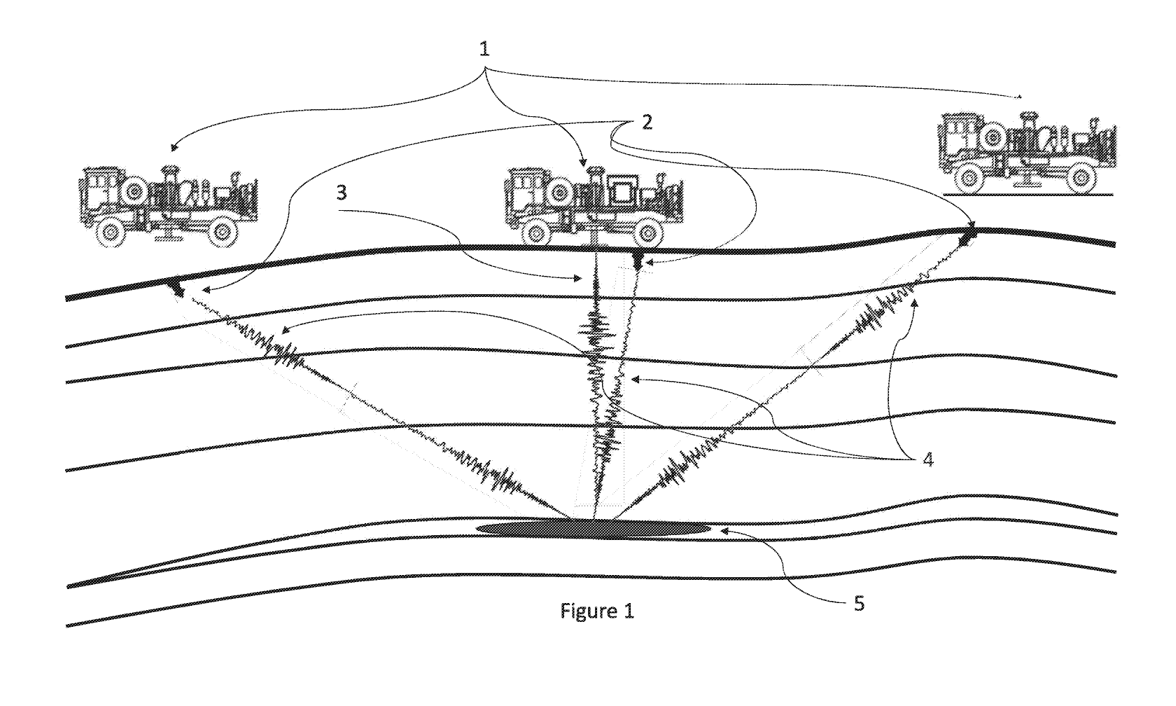

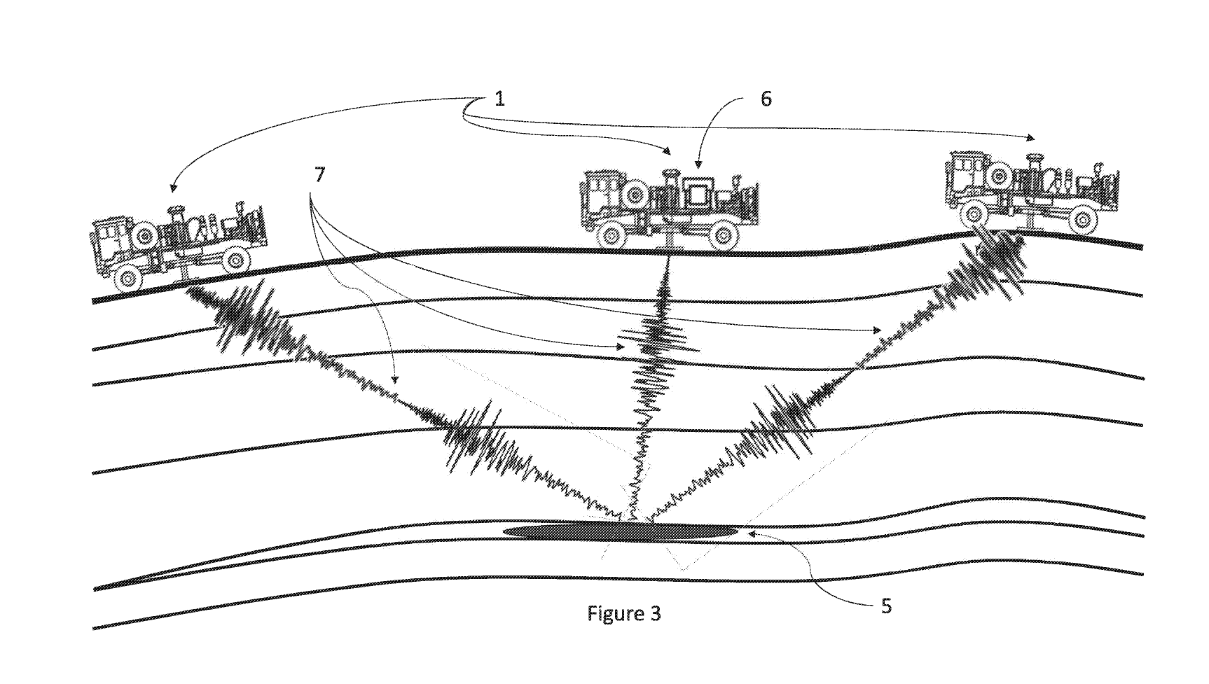

One typical embodiment of the current invention, illustrated by way of non-limiting example only in FIGS. 1 and 3, will include:
1. An array of electronically controlled vibrators (1) capable of producing a complex and/or designed signal (3)
2. A set or plurality of geophones (2), standard or directional, which are positioned at or near the vibrators' impact location.
3. Reflected seismic signals (seismic wavefield) (4), reflected by the target area (5), are acquired by the geophones.
4. The system also includes a recording and processing unit (6), shown in FIG. 3, which includes a signal recorder, capable of recording the synchronized reflected signals acquired by the geophones, as they are reflected by the target area.
5. The system further includes a processing unit, or an independent amplifier, capable of reversing the synchronized signals of the geophones, amplifying them, and feeding them to be injected synchronously into the earth, as seen at (7) in FIG. 3.

In one possible embodiment of the current invention, the vibrator may be modified so as to be incorporated in the mobile vehicle or platform, by mounting the “linear electric engine” used by the vibrator on the vehicle's internal space. In this way, the vibrator can use part of the vehicle's weight as an extended reaction mass. By doing so, the weight of the reaction mass can be practically doubled, thus increasing the force of the vibrations at the target (like soldiers walking with synchronized steps on a bridge).

In one of many typical uses of the TRM Array System, the array of vibrators will be positioned over a target area. Such target areas could be identified from a priori information or by a previous seismic survey.

Once the array of vibrators is positioned above the target area, one of the vibrators or any other energy source (like a weight drop or explosive), will inject a signal into the earth.

The signal, or seismic wavefield, reflected from the target areas will be recorded by the geophones, processed, preferably amplified, and reversed in time, all in a synchronized manner, and then fed to the array of vibrators which are located at the receiver locations which, in turn inject them synchronously back into the earth. The impact of the array of vibrators will focus on the target areas.

The process can be a recursive one, repeating, a preselected number of times, the acquisition of the stronger signal, processing, amplifying, reversing and injecting it back into the ground.

In cases where a suspected target point's precise position is not known, due to the lack of a 3D survey which maps the location (GPS and estimated depth) of the target point, and the array of vibrators is positioned above the area of such suspected target point, the system will be able to apply the desired impact on the target point by relying on the reflective signal acquired from the actual target point, as long as such a reflective signal can be identified by the array of geophones, which are located at the vibrators' impact points.

### Exemplary Implementations of the Current Invention

One of a few possible embodiments of the current invention is related to the task of detecting and destruction of man-made underground structures. This can be done in cases where the location of the target areas is known and mapped in 3D (GPS coordinates and depth), and also in cases where a 3D survey was not executed and the array of vibrators is positioned above the suspected target area.

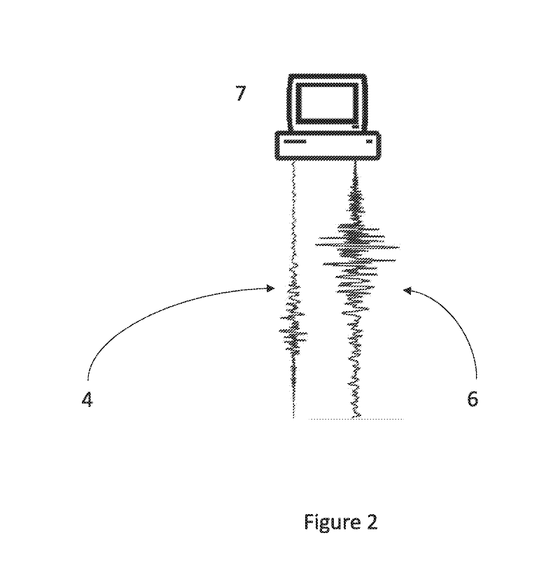

The preferred stages of the process according to the current invention are:
a. A conventional seismic survey is performed, which includes an array of seismic vibrators (preferably, but not limited to, electronic seismic vibrators) and geophones positioned above the target point.
b. A special procedure of data processing is performed, detecting the signals or seismic wavefield returning from the target area (underground structure), time reversing and amplifying them and feeding the amplified signals to the vibrator array located at the positions of the geophones. See, for example, FIG. 2. The vibrators inject the time reversed and amplified signals back into the subsurface. These signals follow exactly the same path they took in the first (data acquisition) step and focus on the target area. This is the essence of the Time Reversal Mirror phenomenon, as proven and used in various other fields. Therefore, electronically controlled vibrators are very likely to produce substantially better accurate signal reverse approximation than the standard pneumatics seismic vibrators currently in use. Thus, their use is preferred for an optimal implementation. The amplified back transmitted signals possess the self-refocusing property of the TRM and should return to the target areas, regardless of the medium characteristic above the target. It should bear sufficient concentrated energy to impact these specific target areas.
c. Using the array of seismic vibrators, preferably, but not necessarily electronically controlled vibrators, transmitting seismic signals in frequencies that are close to the resonant frequency of the man-made structure (if they are known). Due to the large amount of energy required for such a task, this method is effective in shallow subsurface.

The proposed system (of this embodiment of the invention) includes the following components:

An array of mobile seismic vibrators, preferably, but not necessarily electronically controlled vibrators, (FIG. 1, number 1) is deployed at the surface in the vicinity of the target area (FIG. 1, number 5).

A central processing unit, that is coupled to all the array elements, is deployed on one of the seismic vibrators' vehicles or in the close vicinity of the array (FIG. 3, number 6).

As in a conventional seismic survey, the process starts with a single energy source injecting seismic energy. Returned waves are expected to be reflected from subsurface heterogeneities and be detected by the array's geophones. Each geophone detects the wave that arrives to its location and passes the signal to the central processing unit that processes (and may also store) the data. Such central processing unit may be located in one of the vibrators' vehicles, or in a control vehicle.

A special procedure detects and extracts the part of the recorded wavefield which is reflected from the target area. This procedure is a standard signal processing routine. It can be performed in many different way using standard data processing packages.

The central processing unit of the array activates a program that time reverses the extracted wavefield from the target area, preferably amplifies the reversed wavefield, and feeds the reversed and amplified signal to the corresponding vibrator, preferably with exact synchrony with all the other reversed signals of the array.

What emerges from the array is a close approximation of the wavefield, traveling in reverse, which propagates across the medium (typically having extreme heterogeneity), returning along the path of the original wave back to the target area.

In another embodiment of the current invention, the method is applied for Enhanced Oil Recovery (EOR), which is concerned with increasing the amount of crude oil that can be extracted from an oil field. There are three commonly known primary techniques for EOR: thermal recovery, gas injection, and chemical injection. Seismic elastic wave stimulation has been suggested as a way to perform EOR. It relies on the ability of propagating waves to mobilize trapped oil particles. Theoretical investigations and field experiments suggest that such mobilization is possible by the release of trapped oil-blobs from the pores.

The working hypothesis in the conventional approach, that the material properties of the targeted geo-structure (reservoir) and those of the surrounding formations (background model) are known a priori or can be estimated by seismic inversion, is a very strong assumption and does not hold in reality. In this case, reservoir stimulation is never optimal.

To overcome this shortcoming, the current invention suggests the usage of the Time Reversal Mirror (TRM), which is an original approach to optimize focusing of a large transmitting transducer array through an inhomogeneous medium. Arrays of transducers can re-create a wave and send it back to its source as if time had been reversed, without requiring knowledge of the subsurface model.

In general, the efficiency of the TRM depends on the ability to focus a seismic beam in the medium of interest. The presence of velocity fluctuations between the target and the transducers can drastically change the beam profiles. Time-reversal mirrors take advantage of the invariance of the wave equation under a time-reversal operation. This means that, if we want to focus in the transmit mode through any unknown inhomogeneous medium, it is enough to record the distorted wavefield coming from a source located at the focal areas and to time-reverse this field. The time-reversed wavefield back-propagates through the inhomogeneities and optimally refocuses on the source.

The basic scheme is described by three main steps. In the first step (seismic illumination step), the source array seismically illuminates an angular sector that contains the target. The echoes from the target are distorted by the inhomogeneous medium and are recorded by the array in the second step (receiving step). Then, in the last step (focusing step), the source array retransmits the time-reversed seismic wavefield. When the target has a large surface area and/or volume and/or when there are several targets in the illuminated beam, the time-reversal process can be iterated. The iterative mode allows selective focusing on the most seismically reflective target and the final transmit seismic beam will converge on a small portion of this target. Selective focusing can be implemented, for example, by using directional geophones, which have narrow angle reception of signals, thus “filtering” the signals, which may be generated by sources out of the focus. In case such geophones are used, the reversed signal will be identical in terms of the narrow angle, as this is the very nature of TRM.

Optimal self-focusing in the TRM approach would be extremely valuable to improve the efficiency of the EOR by wave stimulation. In this case, the wavefield generated by the reservoir and registered at the surface can be time reversed and re-injected back into the subsurface to be re-focused on the reservoir. The proposed EOR procedure requires four steps.
1. In the first illumination step, seismic vibrators located on the surface seismically illuminate a subsurface area containing the reservoir. (see FIG. 1)
2. In the second step, the observed seismograms are recorded. They contain seismic responses from all subsurface inhomogeneities, including reflection and scattering from the background medium and the scattering field from the reservoir
3. In the third step, the wavefield component responsible for the scattering from the reservoir is extracted from the observed data. This is necessary to obtain maximum energy re-focusing at the reservoir and maximum efficiency of the EOR procedure. The extraction can be achieved by time windowing of the registered wavefield, when the starting time of the wavefield component responsible for the scattering from the reservoir is equal to the arrival time of the direct wave from the vibrator to the reservoir. The latest can be estimated from the a priori information on the velocity model and the reservoir location.
4. The separated signals are then amplified, read in a reversed time, and re-transmitted by vibrators located at the positions of the receivers (FIGS. 2 and 3). The re-transmitted signal propagates back through the same medium (without knowing the model) and refocuses on the reservoir.

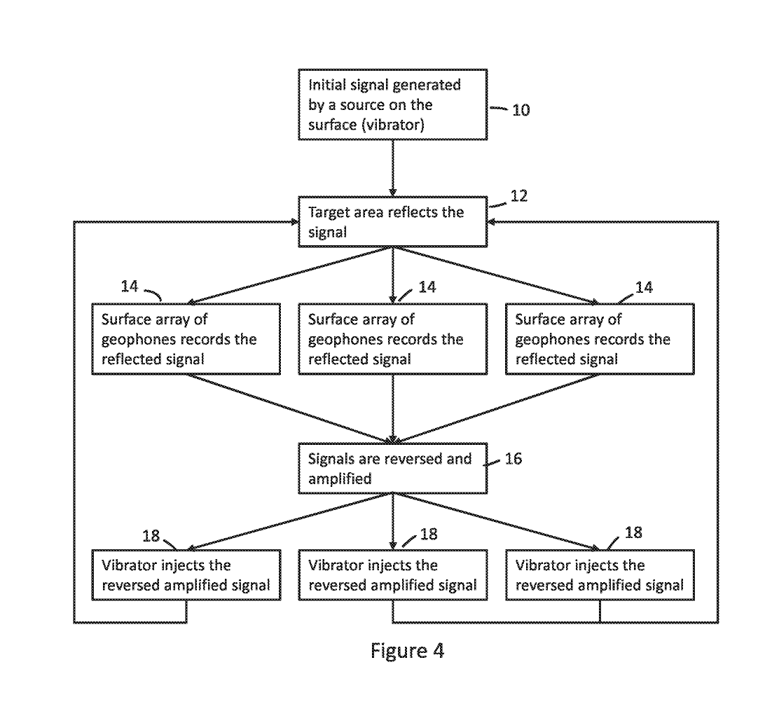

Referring, now, to FIG. 4, there is shown a block diagram (flow chart) of the recursive process, according to embodiments of the invention, when the initial signal is generated on the surface by a vibrator (block 10). The signal is reflected back by a target (block 12). The reflected signal is recorded by a surface array of geophones (blocks 14), which are located at the closest possible location to the vibrators. The signals are reversed and amplified (block 16), and then injected back into the earth in the direction of the target by the array of vibrators (blocks 18).

Drawing 5 illustrates the recursive process, when it is initiated by a signal from the target area (block 20). The signal is recorded by a surface array of geophones (blocks 22) which are close enough to the target to receive the signal. The signals are reversed and amplified (block 26), and then injected back into the earth in the direction of the target by an array of vibrators (blocks 28), which are located at the closest possible location to the receiving geophones.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A system for creating seismic vibrations, the system comprising:
a Time Reversal Mirroring array including:
an array of seismic vibrators,
an array of geophones, which are located at impact points of the seismic vibrators, for receiving seismic signals from a target area;
a processing unit arranged to receive the received seismic signals from the geophones, time reverse the received seismic signals and provide the time reversed seismic signals to the seismic vibrators for injecting the time reversed seismic signals into the earth towards the target area;
wherein the processing unit is configured to orchestrate and synchronize the array of vibrators when injecting the time reversed seismic signals back into the earth.

2. The method according to claim 1, wherein said processor is further arranged to amplify the reversed seismic signals provided to the vibrators.

3. The system according to claim 1, wherein said seismic vibrators are electronically controlled seismic vibrators.

4. The system according to claim 1, wherein said seismic vibrators are electronically controlled seismic vibrators, based on synchronous linear motors.

5. The system according to claim 1, wherein said geophones include an array of narrow angle directional geophones.

6. The system according to claim 1, wherein the array of vibrators includes an array of directional vibrators which inject the TRM signals at an angle, for targeting the target areas.

7. The system according to claim 1, wherein the TRM Array System is a resonating system, injecting into the earth a mirrored synchronized vibration at a defined frequency in order to produce resonance at a target area.

8. A method for creating seismic vibrations, the method comprising:
acquiring by an array of geophones a seismic wavefield arriving from a target in the earth;
processing the acquired wavefield;
time-reversing the processed wavefield; and
back-propagating the time-reversed wavefield through the earth towards the target.

9. The method according to claim 8,
further comprising amplifying the time reversed wavefield; and
wherein the step of back-propagating includes back-propagating the time reversed and amplified wavefield.

10. The method according to claim 8, further comprising injecting an energy signal into the earth; and
wherein said step of acquiring a wavefield includes acquiring a wavefield arriving from the target in response to said injected energy signal.

11. The method according to claim 8, comprising repeating said steps of acquiring, processing, reversing and back-propagating a pre-selected number of times.

12. A method for enhancing efficiency of vibroseismic applications, the method comprising:
injecting seismic energy signals into the earth using an array of electronically controlled seismic vibrators in a direction of a target;
acquiring seismic energy signals returned from the target in response to the injected signals;
performing Time Reversal Mirroring on the acquired energy signals; and
creating seismic signal amplification at the target utilizing at least one of the technologies selected from the group including:
vibrating the target to resonance;
directional signal acquisition from the target;
directional signal injection towards the target.
